(19) United States
(12) Patent Application Publication
(10) Pub. No.: US 2004/0066752 A1
(43) Pub. Date: Apr. 8, 2004

(54) Radio frequency indentification device communications systems, wireless communication devices, wireless communication systems, backscatter communication methods, radio frequency identification device communication methods and a radio frequency identification device

(76) Inventors: Michael A. Hughes, Pasco, WA (US); Richard M. Pratt, Richland, WA (US)

Correspondence Address: WELLS ST. JOHN P.S., 601 W. FIRST AVENUE, SUITE 1300, SPOKANE, WA, 99201, US

(21) Appl. No.: 10/263,826

(22) Filed: Oct. 2, 2002

(51) Int. Cl. H04J 1/16

(52) U.S. Cl. 370/252; 370/278

(57) ABSTRACT

Radio frequency identification device communications systems, wireless communication devices, wireless communication systems, backscatter communications methods, radio frequency identification device communications methods and a wireless communication are provided. In one aspect, a radio frequency identification device communications system includes a reader configured to output a plurality of first wireless communication signals, a radio frequency identification device configured to receive the first wireless communication signals and to output a plurality of second wireless communication signals and wherein the radio frequency identification device is configured to output some of the second wireless communication signals according to a first modulation frequency and responsive to the first wireless communication signals, and to output others of the second wireless communication signals according to a second modulation frequency different than the first modulation frequency and responsive to stimulus internal of the radio frequency identification device.

### TECHNICAL FIELD

This invention relates to radio frequency identification device communications systems, wireless communication devices, wireless communication systems, backscatter communications methods, radio frequency identification device communications methods and a wireless communication.

### BACKGROUND OF THE INVENTION

Remote wireless communications may be implemented using radio frequency (RF) technology. Exemplary applications utilizing RF technology include identification applications including, for example, locating, identifying, and tracking of objects. Radio frequency identification device (RFID) systems have been developed to facilitate identification operations. For example, one device may be arranged to output and receive radio frequency communications and one or more remotely located device may be configured to communicate with the one device using the radio frequency communications. The remotely located device(s) may be referred to as tag(s), while the other device may be referred to as a reader. Some advantages of radio frequency communications of exemplary radio frequency identification device systems include abilities to communicate without contact or line-of-sight, at relatively fast speeds, and with robust communication channels.

Some remote device configurations are arranged to implement wireless communications responsive to interrogation signals from the reader. Typically, the remote device configurations operate as transponders and formulate reply wireless signals responsive to such interrogation signals.

Aspects of the present invention described below provide exemplary methods and apparatuses arranged to provide wireless communication systems of increased flexibility.

### BRIEF DESCRIPTION OF THE DRAWINGS

Preferred embodiments of the invention are described below with reference to the following accompanying drawings.

FIG. 1 is functional block diagram of an exemplary wireless communication system.

FIG. 2 is a functional block diagram of components of an exemplary wireless communication device of the system.

FIG. 3 is a functional block diagram of components of another exemplary wireless communication device of the system.

FIG. 4 is a flow chart of an exemplary methodology executable within the device of FIG. 3.

FIG. 5 is a flow chart of an exemplary methodology executable within the device of FIG. 4.

### DETAILED DESCRIPTION OF THE PREFERRED EMBODIMENTS

Attention is directed to the following commonly assigned applications, which are incorporated herein by reference:

U.S. patent application Ser. No. ______ Attorney Docket 12961-B (BA4-095), entitled “Method of Simultaneously Reading Multiple Radio Frequency Tags, RF Tag, and RF Reader,” by inventors Emre Ertin, Richard M. Pratt, Mike A. Hughes, Kevin L. Priddy, and Wayne M. Lechelt; U.S. patent application Ser. No. ______ Attorney Docket 13095-B (BA4-096), entitled “RFID System and Method Including Tag ID Compression,” by inventors Richard M. Pratt and Mike A. Hughes; U.S. patent application Ser. No. ______ Attorney Docket 13096-B (BA4-097), entitled “System and Method to Identify Multiple RF Tags,” by inventors Mike A. Hughes and Richard M. Pratt; U.S. patent application Ser. No. ______ Attorney Docket 13154-B (BA4-098), entitled “Radio Frequency Identification Devices, Backscatter Communication Device Wake-up Methods, Communication Device Wake-up Methods and A Radio Frequency Identification Device Wake-up Method,” by inventors Richard Pratt and Mike Hughes; U.S. patent application Ser. No. ______ Attorney Docket 13218-B (BA4-099), entitled “Wireless Communication Systems, Radio Frequency Identification Devices, Methods of Enhancing a Communications Range of a Radio Identification Frequency Device, and Wireless Communication Methods,” by inventors Richard Pratt and Steven B. Thompson; U.S. patent application Ser. No. ______ Attorney Docket 13219-B (BA4-100), entitled “Wireless Communications Devices, Methods of Processing a Wireless Communication Signal, Wireless Communication Synchronization Methods and a Radio Frequency Identification Device Communication Method,” by inventors Richard M. Pratt and Steven B. Thompson; U.S. patent application Ser. No. ______ Attorney Docket 13252-B (BA4-101), entitled “Wireless Communications Systems, Radio Frequency Identification Devices, Wireless Communications Methods, and Radio Frequency Identification Device Communications Methods,” by inventors Richard Pratt and Steven B. Thompson; U.S. patent application Ser. No. ______ Attorney Docket 13097-B (BA4-102), entitled “A Challenged-Based Tag Authentication Model,” by inventors Mike A. Hughes and Richard M. Pratt; U.S. patent application Ser. No. 09/589,001, filed Jun. 6, 2000, entitled “Remote Communication System and Method,” by inventors R. W. Gilbert, G. A. Anderson, K. D. Steele, and C. L. Carrender; U.S. patent application Ser. No. 09/802,408; filed Mar. 9, 2001, entitled “Multi-Level RF Identification System,” by inventors R. W. Gilbert, G. A. Anderson, and K. D. Steele; U.S. patent application Ser. No. 09/833,465, filed Apr. 11, 2001, entitled “System and Method for Controlling Remote Device,” by inventors C. L. Carrender, R. W. Gilbert, J. W. Scott, and D. Clark; U.S. patent application Ser. No. 09/588,997, filed Jun. 6, 2000, entitled “Phase Modulation in RF Tag,” by inventors R. W. Gilbert and C. L. Carrender; U.S. patent application Ser. No. 09/589,000, filed Jun. 6, 2000, entitled “Multi-Frequency Communication System and Method,” by inventors R. W. Gilbert and C. L. Carrender; U.S. patent application Ser. No. 09/588,998; filed Jun. 6, 2000, entitled “Distance/Ranging by Determination of RF Phase Delta,” by inventor C. L. Carrender; U.S. patent application Ser. No. 09/797,539, filed Feb. 28, 2001, entitled “Antenna Matching Circuit,” by inventor C. L. Carrender; U.S. patent application Ser. No. 09/833,391, filed Apr. 11, 2001, entitled “Frequency Hopping RFID Reader,” by inventor C. L. Carrender.

According to one aspect of the invention, a radio frequency identification device communications system comprises a reader configured to output a plurality of first wireless communication signals, a radio frequency identification device configured to receive the first wireless communication signals and to output a plurality of second wireless communication signals and wherein the radio frequency identification device is configured to output some of the second wireless communication signals according to a first modulation frequency and responsive to the first wireless communication signals, and to output others of the second wireless communication signals according to a second modulation frequency different than the first modulation frequency and responsive to stimulus internal of the radio frequency identification device.

According to another aspect of the invention, a wireless communication device comprises communication circuitry configured to process a plurality of first wireless communication signals from a reader and to control outputting of a plurality of second wireless communication signals to the reader using backscatter modulation and wherein the communication circuitry is further configured to synchronize communication of selected ones of the second wireless communication signals responsive to the first communication signals and to asynchronously communicate selected others of the second wireless communication signals.

According to an additional aspect of the invention, a wireless communications system comprises a reader configured to output a plurality of first wireless signals and to receive a plurality second wireless signals, a plurality of communication devices configured to receive the first wireless signals and to output the second wireless signals using backscatter modulation and wherein the communication devices are individually configured to implement the backscatter modulation utilizing a plurality of different modulation frequencies.

According to yet another aspect of the invention, a backscatter communications method comprises providing a reader and a communication device, outputting a plurality of first wireless communication signals using a reader, receiving the first wireless communication signals using the communication device and communicating a plurality of second wireless communication signals using the communication device, the communicating comprising first backscatter modulating using the communication device according to a first modulation frequency and responsive to receiving at least one of the first wireless communication signals and second backscatter modulating using the communication device according to a second modulation frequency different than the first modulation frequency and independent of the first wireless communication signals.

According to still yet another aspect of the invention, a radio frequency identification device communications method comprises providing a radio frequency identification device, receiving a plurality of first wireless communication signals from a reader using the radio frequency identification device, providing a stimulus unrelated to the first wireless communication signals and communicating a plurality of second wireless communication signals using the radio frequency identification device, wherein the communicating comprises communicating at least some of the second wireless communication signals responsive to the providing the stimulus.

According to another aspect of the invention, a radio frequency identification device comprises an antenna configured to communicate wireless signals, radio frequency identification device communication circuitry coupled with the antenna and configured to process a plurality of first wireless signals received from a reader and to control the outputting of a plurality of second wireless signals using the antenna to implement radio frequency identification device communications with the reader and wherein the radio frequency identification device communication circuitry is configured to utilize a first modulation frequency to control the outputting of a first one of the second wireless signals and a second modulation frequency different than the first modulation frequency to control the outputting of a second one of the second wireless signals.

According to still another aspect of the invention, a radio frequency identification device communications method comprises providing a reader, providing a radio frequency identification device, communicating a plurality of first wireless communication signals using the reader, receiving the first wireless communication signals using the radio frequency identification device, backscatter modulating using the radio frequency identification device and according to a first modulation frequency to communicate some of a plurality of second wireless communication signals responsive to the receiving the first wireless communication signals, providing a stimulus unrelated to the first wireless communication signals backscatter modulating using the radio frequency identification device and according to a second modulation frequency different than the first modulation frequency to communicate others of the second wireless communication signals, wherein the backscatter modulating according to the second modulation frequency comprises backscatter modulating independent of the receiving the first wireless communication signals and responsive to the providing the stimulus, receiving the some and the others of the second wireless communication signals using the reader and communicating a predefined one of the first wireless communication signals responsive to receiving at least one of the others of the second wireless communication signals.

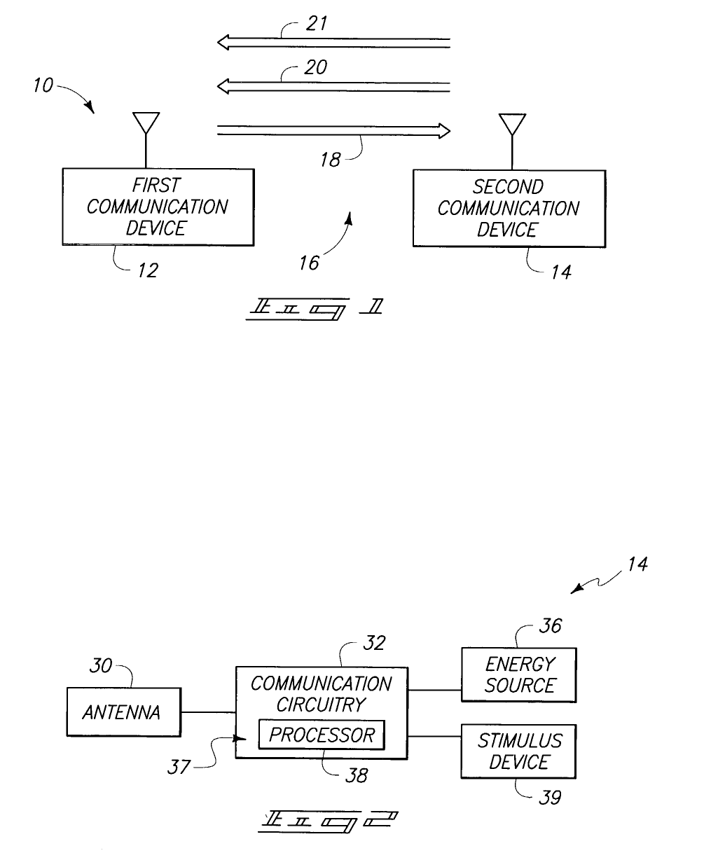

Referring to FIG. 1, an exemplary wireless communications system 10 is depicted. The exemplary system 10 includes a first communication device 12 and a second communication device 14. The depicted system 10 including a single device 12 and a single device 14 is illustrative and additional communication devices are typically provided in other system configurations.

First and second communication devices 12, 14 are arranged to implement wireless communications 16 in the depicted exemplary embodiment. Exemplary wireless communications 16 include electromagnetic communication signals, such as radio frequency signals. Alternatively, wireless communications 16 may comprise infrared signals, acoustic signals, or any other appropriate wireless signals capable of being communicated between devices 12, 14.

As shown, possible wireless communications 16 include first wireless communication signals 18 communicated from first communication device 12 and second wireless communication signals 20, 21 communicated from second communication device 14. Signals 18 include modulated signals comprising data and/or commands, for example. Device 12 may also communicate continuous wave signals (e.g., 900 MHz or 2.45 GHz) in at least one embodiment enabling backscatter communications. According to aspects of the invention, second communication device 14 is arranged to communicate second wireless signals 20, 21 comprising respective different signals as described further below.

System 10 is provided to illustrate exemplary structural and method aspects of the present invention. In one possible implementation, system 10 is implemented as a radio frequency identification device (RFID) communications system. For example, in such an arrangement, first communication device 12 may be implemented as a reader, and second communication device 14 may be implemented as a transponder, such as an RFID tag. In one possible RFID system 10, one device 12 is configured to communicate with a plurality of devices 14. A plurality of systems 10 may also be utilized in close proximity to one another.

Wireless signals 18 may be referred to as forward link wireless signals and wireless signals 20 may be referred to as return link wireless signals typically communicated responsive to forward link wireless signals 18. According to aspects of the invention discussed further below, wireless signals 21 may be communicated independent of first wireless signals 18.

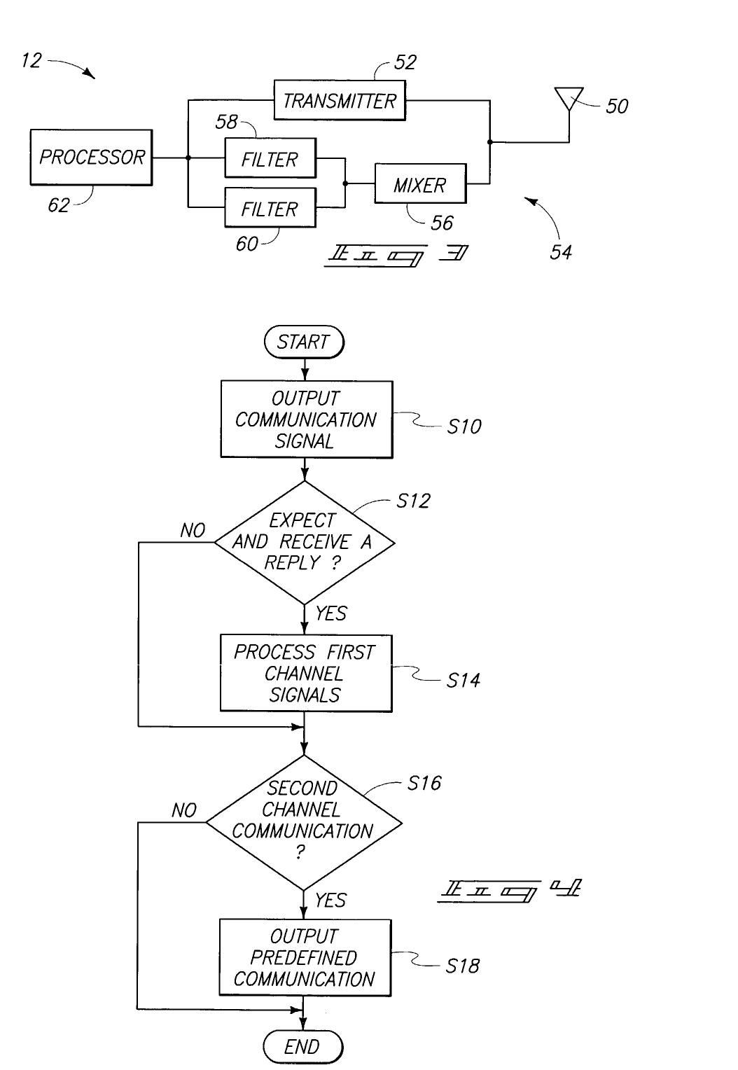

Referring to FIG. 2, an exemplary arrangement of second communication device 14 is shown. The exemplary configuration of device 14 includes an antenna 30, communication circuitry 32, an energy source 36, and a stimulus device 39.

Energy source 36 may comprise one of a plurality of possible configurations corresponding to the implementation of communication device 14. Communication device 14 may be implemented in passive, semi-passive or active configurations in exemplary arrangements.

In semi-passive implementations, energy source 36 may comprise a battery utilized to provide electrical energy to communication circuitry 32 to implement processing of wireless signals 18 while electromagnetic energy received within device 14 is utilized to generate wireless signals 20, 21.

For active implementations, energy source 36 may also comprise a battery arranged to provide operational electrical energy to communication circuitry 32 similar to the semi-passive implementation. In addition, energy source 36 may also be utilized to generate radio frequency energy for communication of signals 20, 21.

For passive implementations of device 14, received electromagnetic energy (e.g., radio frequency energy) is utilized to provide operational electrical energy to communication circuitry 32 of device 14 as well as provide radio frequency energy for communicating wireless signals 20. In such an implementation, energy source 36 may comprise a power antenna and discrete components arranged to convert received electromagnetic energy into usable operational electrical energy.

It may be desired to conserve electrical energy of a battery (if utilized) in order to extend the useful, operational life of the battery. In one embodiment, communication circuitry 32 is arranged to operate in a plurality of operational modes, including at least first, second and third different operational modes in one embodiment. Individual ones of the operational modes have different power requirements and consume electrical energy at different rates. Additionally, wake-up circuitry may be utilized within device 14 to control operation thereof in the different operational modes. Exemplary operational modes are described in a U.S. patent application Ser. No. ______ entitled “Radio Frequency Identification Devices, Backscatter Communication Device Wake-up Methods, Communication Device Wake-up Methods and A Radio Frequency Identification Device Wake-up Method,” naming Richard Pratt and Mike Hughes as inventors, having Docket No. 13154-B, and incorporated herein by reference.

Antenna 30 is arranged to receive electromagnetic energy including signals 18 and to output electromagnetic energy including signals 20, 21. Antenna 30 may comprise a single antenna for communication of signals 18, 20, 21 or include a plurality of respective dedicated antennas for communication of signals 18, 20, 21. An additional antenna (not shown) may be provided in passive applications to provide operational energy.

According to at least one configuration, communication circuitry 32 includes processing circuitry 37 which receives operational energy from energy source 36. One configuration of processing circuitry 37 may be implemented as a processor 38. An exemplary processor 38 may be implemented as a model number MSP430F1121 available from Texas Instruments, Inc. Other configurations of processing circuitry and processors are possible.

Processor 38 of communication circuitry 32 is configured to execute instructions to control communication operations of device 14. For example, processor 38 of communication circuitry 32 is arranged to process received wireless signals 18 and to control communication of outputted wireless signals 20, 21. In one arrangement, processor 38 is configured to control antenna 30 to generate wireless signals 20, 21 using backscatter modulation communication techniques. Communication circuitry 32 may control outputting of wireless signals 20 using backscatter modulation according to at least one radio frequency identification device communication protocol. Signals 21 may be communicated using device 14 to implement additional exemplary functionality described herein.

Communication circuitry 32 controls electrical characteristics of antenna 30 according to one backscatter embodiment. Processor 38 may provide a modulation signal to alter electrical characteristics of antenna 30 wherein electromagnetic energy, such as a 900 MHz or 2.45 GHz continuous wave signal from device 12, is selectively reflected by antenna 30. Antenna 30 reflects electromagnetic energy creating wireless signals 20, 21 responsive to modulation signals from processor 38 according to one exemplary backscatter implementation.

The modulation signals may be encoded with information to be communicated from device 14 to device 12. Exemplary information includes identification information, such as a unique serial number which identifies the communicating device 14, or any other desired information or commands to be communicated. According to one exemplary arrangement, communication devices 12, 14 are configured to communicate wireless signals 18, 20, 21 using on/off key (OOK) modulation, such as a FM0 or FM1 encoding scheme. Other types of modulation or schemes may be utilized to communicate information between devices 12, 14.

Communication circuitry 32 arranged to implement RFID communications may be referred to as radio frequency identification device communication circuitry. Communication circuitry 32 is operable to control communication of wireless signals 20 responsive to processing of one or more wireless signal 18 in one embodiment. For example, circuitry 32 may implement transponder communications using signals 0.20 in one exemplary embodiment. Aspects of the invention also provide communication of signals 21 using device 14 and implemented by communication circuitry 32 to provide additional communication capabilities described herein.

Processing of received signals 18 may include extracting an identifier from the wireless signals 18 (e.g., an identifier of the communicating device 12 and/or identifying device 14) and also include processing of data and/or commands within signals 18. Responsive to receiving and processing of signals 18, device 14 may selectively output or communicate wireless signals 20 including identification information or other desired requested information from first communication device 12.

Stimulus device 39 is arranged to generate stimulus signals to control operations of device 14 (e.g., responsive to conditions surrounding the device 14). For example, device 39 may sense or monitor one or more environmental condition and provide information regarding the environmental condition (e.g., temperature information, pressure information, altitude information, acceleration information, etc.) about device 14. In one configuration, device 39 is configured to trigger or generate a signal responsive to a predefined threshold being detected. The described monitored conditions are exemplary and device 39 is configured to monitor one or more other condition in other embodiments. Any desired condition may be monitored and utilized by stimulus device 39 to generate stimulus signals. Alternatively, stimulus device 39 may comprise or correspond to an external article of device 14 and associated with device 14, and arranged to communicate with processor 38 of device 14. Accordingly, device 14 itself, or the article to which the device 14 is associated, may initiate communications without waiting for an interrogation signal from device 12 using signals 21 and, for example, responsive to output from stimulus device 39 or other criteria.

In typical arrangements, device 14 communicates second wireless signals 20 responsive to interrogation or polling signals 18 originating from device 12. Communication of signals 18, 20 within system 10 provides a transponder communication system. Signals 18, 20 comprise synchronous signals or synchronized communications inasmuch as signals 20 are communicated from device 14 responsive to reception of signals 18. Accordingly, device 14 may be considered to synchronize communication of signals 20 with or responsive to signals 18.

Aspects of the present invention enable communication of signals 21 comprising asynchronous communications or signals using device 14. For example, signals 21 may be communicated independently or not responsive to reception of signals 18. Signals 21 in at least one aspect, may be communicated responsive to stimulus generated internally of device 14, stimulus received within device 14, or stimulus otherwise independent or unrelated to signals 18. For example, signals 21 may be communicated responsive to stimulus signals outputted using stimulus device 39 as mentioned above. In other arrangements, device 14 may communicate signals 21 responsive to a timer of processor 38 counting a predetermined time since the last communications were implemented. Other stimulus internal of device 14, received within device 14, or otherwise independent of signals 18 may be utilized to stimulate communication of signals 21 using device 14.

Communication of signals 21 is beneficial in exemplary situations wherein device 14 wishes to communicate information to device 12 and communications using synchronous signals 20 are inappropriate or not desired. For example, perhaps a signal 18 has not been communicated for an extended period of time and device 14 wishes to communicate information without waiting for reception of the next signal 18 (if any).

In but one arrangement, device 14 is configured to communicate signals 20, 21 using a plurality of different modulation frequencies or channels. According to an exemplary backscatter modulation communication arrangement, device 14 may communicate signals 20 responsive to a respective modulation signal having a modulation frequency, or intermediate frequency (IF), of 2 MHz and communicate signals 21 responsive to a respective modulation signal having a modulation frequency of 1 MHz. Accordingly, at least one of devices 14 may be arranged to communicate wireless signals 20, 21 having a plurality of different modulation frequencies.

According to additional aspects of the invention, device 14 may select appropriate moments in time to communicate asynchronous communications. In one possible implementation, processor 38 of device 14 is configured to detect the presence of radio frequency energy. For example, device 14 may include a comparator coupled with antenna 30 and the comparator is arranged to detect and indicate radio frequency energy above a predefined threshold to remove spurious signals. Additional details of exemplary detection of radio frequency energy using a comparator are discussed in the U.S. patent application Ser. No. ______ having docket number 0.13154-B (BA4-098) and incorporated by reference above.

Responsive to the detection of radio frequency energy, processor 38 of device 14 may operate to generate one or more communication signal 21 if asynchronous communications are desired. Processor 38 may formulate an appropriate modulation signal (e.g., 1 MHz) to backscatter the radio frequency energy using antenna 30 to communicate signal 21.

Appropriate radio frequency energy for formulating signals 21 may comprise radio frequency energy from device 12 or incidental radio frequency energy from other sources (e.g., another reader in proximity to the device 12 communicating with device 14). In exemplary configurations, device 12 communicating with device 14 may periodically provide a continuous wave signal as described above to enable backscatter communication of signals 21. Also, device 14 may backscatter radio frequency energy from the device 12 communicating with another device 14, for example. Accordingly, any appropriate radio frequency energy (i.e., having an adequate level) may be utilized to implement asynchronous communications. Such may additionally include, for example, 802.11 wireless networks or other illumination sources of RF.

Referring to FIG. 3, an exemplary arrangement of device 12 is shown. The depicted configuration of device 12 comprises a multiple IF capable reader. Device 12 includes a transmitter 52, a receiver 54, and a processor 62 in the depicted embodiment. Processor 62 provides control of communication of signals 18 as well as processing of received signals 20, 21. Transmitter 52 is arranged to implement communication of signals 18. Receiver 54 is configured to receive signals 20, 21.

In the depicted exemplary embodiment, receiver 54 of device 12 includes a mixer 56 and filters 58, 60 to provide a plurality of channels. Mixer 56 is arranged to demodulate the received signals 20, 21 removing the carrier and providing respective IF signals. Filters 58, 60 have passbands corresponding to the IF modulation of respective signals 20, 21. Accordingly, filters 58, 60 individually present respective signals 20, 21 to processor 62 which monitors the reception of the signals 20, 21 and implements appropriate processing of signals 20, 21.

In one configuration, and following communication of a signal 18, processor 62 of device 12 may monitor the channel corresponding to signals 20 (e.g., output of filter 58) to await for a reply from device 14. Processor 62 may also periodically monitor the channel corresponding to signals 21 (e.g., output of filter 60) to determine if asynchronous communications have been attempted by device 14.

In one configuration, device 14 may implement communication of one or more signal 21 to initiate a service request operation. For example, device 14 communicates a signal 21 comprising a “SERVICE REQUEST” message. Device 12 receives the signal 21 within the respective channel and thereafter outputs a predefined signal 18 comprising, for example, a “SERVICE QUERY” signal. Upon receipt of the predefined signal 18, device 14 may operate to communicate signals 20 to convey or communicate the desired information. Alternatively, device 14 may directly communicate the information using signals 21. As described, the exemplary system 10 has a dedicated response frequency for signals 21 including service requests.

If a service request was unintelligible (e.g., multiple devices 14 may have requested service), device 12 may poll known devices 14 and/or enter a discovery mode to detect devices 14 in an attempt to locate the communicating device 14. If device 14 fails to receive a SERVICE QUERY signal responsive to a SERVICE REQUEST message, it may perform a random interval hold-off and re-request service.

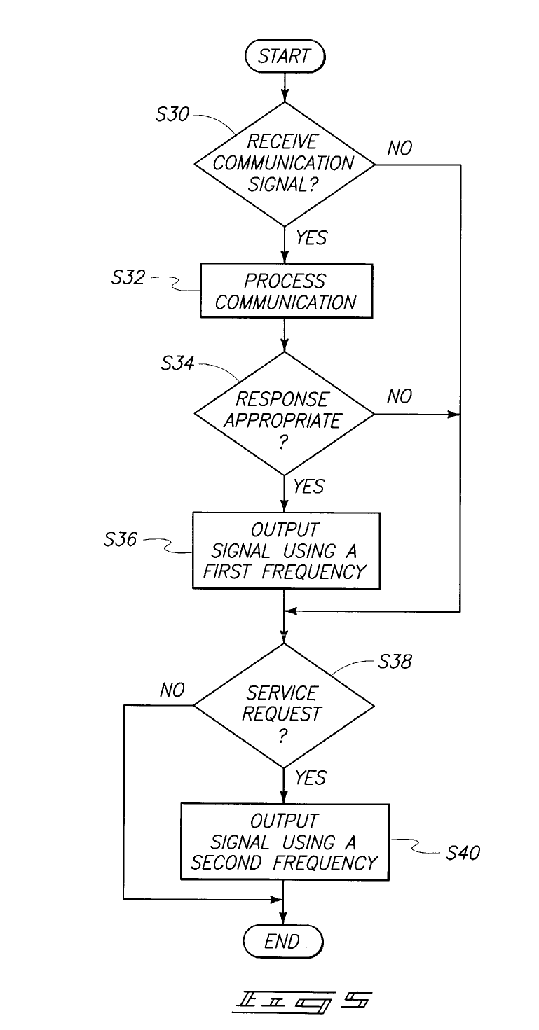

Referring to FIG. 4, an exemplary methodology executable by processor 62 of communication device 12 for implementing communications is depicted. Other methods are possible which use more, less or alternative steps.

Initially, at a step S10, the processor may communicate a wireless communication signal 18 for reception within one or more communication device 14.

At a step S12, it is determined whether a reply is expected responsive to the outputted communication signal and if an expected reply is received.

If the condition of step S12 is negative, the processor proceeds to a step S16.

Alternatively, if the condition of step S12 is affirmative, the processor proceeds to a step S14 to process signals 20 received via a first channel, corresponding to filter 58, for example. Such signals received via the first channel may be responsive to the signal outputted in step S10.

At a step S16, the processor is arranged to monitor a second channel to determine if an asynchronous communication signal 21 has been received. For example, processor can monitor a channel provided by filter 60 to determine if any asynchronous communications described above have been received. In one example, such communications may be buffered for reception and processing by processor 62.

If the condition of step S16 is negative, the depicted methodology ends, may be repeated, or other actions performed.

If the condition of step S16 is affirmative, the processor proceeds to a step S18 to output a predefined communication, such as a SERVICE QUERY, responsive to the asynchronous communications. Communications may thereafter proceed using signals 18, 20 in one arrangement.

Referring to FIG. 5, an exemplary methodology executable using processor 38 of device 14 to implement communications is depicted. Other methods are possible which use more, less or alternative steps.

Initially, at a step S30, the processor determines whether a communication signal 18 has been received.

If the result of step S30 is negative, the processor proceeds to a step S38.

Alternatively, if the condition of step S30 is affirmative, the processor proceeds to a step S32 to process the received communication.

At a step S34, the processor determines whether a response to the received signal is appropriate.

If the condition of step S34 is negative, the processor proceeds to step S38.

Alternatively, if the condition of step S34 is affirmative, the processor proceeds to a step S36 to formulate and output a communication signal 20 using a first modulation frequency.

At step S38, the processor determines whether a service request is desired or if information is otherwise available to be asynchronously communicated to device 12.

If the condition of step S38 is affirmative, the processor outputs an asynchronous signal 21 using a second modulation frequency at a step S40.

If the condition of step S38 is negative, or following the execution of step S40, the processor may end or repeat the depicted methodology, or perform other operations.

Aspects of the present invention enable a device 14 to request service asynchronously instead of waiting for device 12 to poll the device 14 for service. The communication capabilities reduce consumption of energy from batteries of device 14 (if provided) inasmuch as such energy is not consumed responding to polling requests if there is no data to share. Exemplary aspects of devices 14 including stimulus devices 39 enable such device 14 to function in applications which provide communications if conditions exceed certain set points or thresholds.

Exemplary applications of systems 10 described herein include inventory management, process monitoring, process control, diagnostics and security. For inventory management, devices 14 may be utilized for simple inventory/locating tasks of critical, high-value or other items in storage, transport, or final use locations. Such items may be sensitive to humidity and shock or other conditions. The provision of condition monitoring capabilities in systems 10 enables an ability to report additional information to customers than merely identification information.

Systems 10 of the present invention may be utilized for processing monitoring and control applications wherein wireless communications are desired due to operational constraints (e.g., rotating machinery, pressure boundaries, etc.). System 10 could transmit process data to a main monitoring/control station and receive control commands to change a process or locally implement process control changes based upon monitored inputs and transmit process changes to a main control station, for example. An ability to perform asynchronous communications without being directly addressed is a distinct advantage.

Similar to process control, adding monitoring capabilities to devices 14 in diagnostic applications allows additional information to be obtained which could be used for proactive maintenance scheduling versus periodic maintenance scheduling. Other applications are possible.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A radio frequency identification device communications system comprising:
a reader configured to output a plurality of first wireless communication signals;
a radio frequency identification device configured to receive the first wireless communication signals and to output a plurality of second wireless communication signals; and
wherein the radio frequency identification device is configured to output some of the second wireless communication signals according to a first modulation frequency and responsive to the first wireless communication signals, and to output others of the second wireless communication signals according to a second modulation frequency different than the first modulation frequency and responsive to stimulus internal of the radio frequency identification device.

2. The system of claim 1 wherein the stimulus is generated within the radio frequency identification device.

3. The system of claim 1 wherein the radio frequency identification device comprises a stimulus device configured to generate the stimulus.

4. The system of claim 3 wherein the stimulus device is external of the radio frequency device.

5. The system of claim 1 wherein the reader is configured to communicate a predefined one of the first wireless communication signals responsive to the reception of one of the others of the second wireless communication signals.

6. The system of claim 1 wherein the reader is configured periodically monitor for the reception of the others of the second wireless communication signals.

7. The system of claim 1 wherein the radio frequency identification device is configured to synchronize communication of selected ones of the second wireless communication signals responsive to the first wireless communication signals and to asynchronously communicate the others of the second wireless communication signals.

8. The system of claim 1 wherein the radio frequency identification device comprises digital circuitry, and further comprising a battery configured to provide operational electrical energy to the digital circuitry.

9. The system of claim 1 wherein the radio frequency identification device comprises digital circuitry configured to receive operational electrical energy from received radio frequency energy.

10. The system of claim 1 wherein the radio frequency identification device is configured to output the others of the second wireless communication signals independent of the first wireless communication signals.

11. The system of claim 1 wherein the radio frequency identification device is configured to output the others of the second wireless communication signals not responsive to the first wireless communication signals.

12. The system of claim 1 wherein the radio frequency identification device is configured to output the some and the others of the second wireless communication signals using backscatter modulation.

13. The system of claim 1 wherein the radio frequency identification device is configured to detect the presence of radio frequency energy and to output the others of the second wireless communication signals responsive to the detection.

14. The system of claim 1 wherein the radio frequency identification device comprises a passive device.

15. The system of claim 1 wherein the radio frequency identification device comprises a semi-passive device.

16. A wireless communication device comprising:
communication circuitry configured to process a plurality of first wireless communication signals from a reader and to control outputting of a plurality of second wireless communication signals to the reader using backscatter modulation; and
wherein the communication circuitry is further configured to synchronize communication of selected ones of the second wireless communication signals responsive to the first communication signals and to asynchronously communicate selected others of the second wireless communication signals.

17. The device of claim 16 wherein the communication circuitry is configured to asynchronously communicate the selected others of the second wireless communication signals responsive to a stimulus unrelated to the first wireless communication signals.

18. The device of claim 17 further comprising a stimulus device coupled with the communication circuitry and configured to generate the stimulus.

19. The device of claim 16 wherein the communication circuitry comprises digital circuitry, and further comprising a battery configured to provide operational electrical energy to the digital circuitry.

20. The device of claim 16 wherein the communication circuitry comprises digital circuitry configured to receive operational electrical energy from received radio frequency energy.

21. The device of claim 16 wherein the communication circuitry is configured to backscatter modulate according to a first modulation frequency to output the selected ones of the second wireless communication signals and according to a second modulation frequency different than the first modulation frequency to output the selected others of the second wireless communication signals.

22. The device of claim 16 wherein the communication circuitry comprises radio frequency identification device communication circuitry.

23. The device of claim 16 wherein the communication circuitry is configured to output the selected others of the second wireless communication signals independent of the first wireless communication signals.

24. The device of claim 16 wherein the communication circuitry is configured to output the selected others of the second wireless communication signals not responsive to the first wireless communication signals.

25. The device of claim 16 wherein the communication circuitry is configured to detect the presence of radio frequency energy and to asynchronously communicate the selected others of the second wireless communication signals responsive to the detection.

26. A wireless communications system comprising:
a reader configured to output a plurality of first wireless signals and to receive a plurality second wireless signals;
a plurality of communication devices configured to receive the first wireless signals and to output the second wireless signals using backscatter modulation; and
wherein the communication devices are individually configured to implement the backscatter modulation utilizing a plurality of different modulation frequencies.

27. The system of claim 26 wherein the communication devices comprise radio frequency identification devices.

28. A radio frequency identification device comprising:
an antenna configured to communicate wireless signals;
radio frequency identification device communication circuitry coupled with the antenna and configured to process a plurality of first wireless signals received from a reader and to control the outputting of a plurality of second wireless signals using the antenna to implement radio frequency identification device communications with the reader; and
wherein the radio frequency identification device communication circuitry is configured to utilize a first modulation frequency to control the outputting of a first one of the second wireless signals and a second modulation frequency different than the first modulation frequency to control the outputting of a second one of the second wireless signals.

29. A backscatter communications method comprising:
providing a reader and a communication device;
outputting a plurality of first wireless communication signals using the reader;
receiving the first wireless communication signals using the communication device; and
communicating a plurality of second wireless communication signals using the communication device, the communicating comprising:
first backscatter modulating using the communication device according to a first modulation frequency and responsive to receiving at least one of the first wireless communication signals; and
second backscatter modulating using the communication device according to a second modulation frequency different than the first modulation frequency and independent of the first wireless communication signals.

30. The method of claim 29 further comprising providing a stimulus independent of the first wireless communication signals, and wherein the second backscatter modulating comprises modulating responsive to the stimulus.

31. The method of claim 30 wherein the providing the stimulus comprises providing using a stimulus device.

32. The method of claim 29 further comprising communicating a predefined one of the first wireless communication signals using the reader responsive to receiving one of the second wireless communication signals having the second modulation frequency using the reader.

33. The method of claim 29 further comprising:
receiving radio frequency energy within the communication device; and
processing the first wireless communication signals within the communication device using the radio frequency energy.

34. The method of claim 29 further comprising:
providing operational energy within the communication device using a battery; and
processing the first wireless communication signals within the communication device using the operational energy.

35. The method of claim 29 wherein the providing comprises providing the communication device comprising a radio frequency identification device.

36. The method of claim 29 further comprising detecting the presence of radio frequency energy, and wherein the second backscatter modulating is responsive to the detecting.

37. A radio frequency identification device communications method comprising:
providing a radio frequency identification device;
receiving a plurality of first wireless communication signals from a reader using the radio frequency identification device;
providing a stimulus unrelated to the first wireless communication signals; and
communicating a plurality of second wireless communication signals using the radio frequency identification device, wherein the communicating comprises communicating at least some of the second wireless communication signals responsive to the providing the stimulus.

38. The method of claim 37 wherein the providing the stimulus comprises providing using a stimulus device.

39. The method of claim 37 wherein the communicating comprises asynchronously communicating the at least some of the second wireless communication signals and communicating others of the second wireless communication signals synchronized with the first wireless communication signals.

40. The method of claim 37 further comprising:
receiving radio frequency energy within the radio frequency identification device; and
processing the first wireless communication signals within the radio frequency identification device using the radio frequency energy.

41. The method of claim 37 further comprising:
providing operational energy within the radio frequency identification device using a battery; and
processing the first wireless communication signals within the radio frequency identification device using the operational energy.

42. The method of claim 37 wherein the communicating comprises communicating others of the second wireless communication signals according to a first modulation frequency and communicating the at least some of the second wireless communication signals according to a second modulation frequency different than the first modulation frequency.

43. The method of claim 37 wherein the communicating comprises communicating others of the second wireless communication signals responsive to the receiving and communicating the at least some of the second wireless communication signals independent of the receiving.

44. The method of claim 37 wherein the communicating comprises backscatter modulating.

45. The method of claim 37 wherein the communicating comprises communicating the at least some of the second wireless communication signals not responsive to the receiving.

46. The method of claim 37 further comprising detecting the presence of radio frequency energy, and wherein the communicating the at least some of the second wireless communication signals is responsive to the detecting.

47. A radio frequency identification device communications method comprising:
providing a reader;
providing a radio frequency identification device;
communicating a plurality of first wireless communication signals using the reader;
receiving the first wireless communication signals using the radio frequency identification device;
backscatter modulating using the radio frequency identification device and according to a first modulation frequency to communicate some of a plurality of second wireless communication signals responsive to the receiving the first wireless communication signals;
providing a stimulus unrelated to the first wireless communication signals;
backscatter modulating using the radio frequency identification device and according to a second modulation frequency different than the first modulation frequency to communicate others of the second wireless communication signals, wherein the backscatter modulating according to the second modulation frequency comprises backscatter modulating independent of the receiving the first wireless communication signals and responsive to the providing the stimulus;
receiving the some and the others of the second wireless communication signals using the reader; and
communicating a predefined one of the first wireless communication signals responsive to receiving at least one of the others of the second wireless communication signals.
